(19) United States
(12) Patent Application Publication
(10) Pub. No.: US 2017/0169934 A1
(43) Pub. Date: Jun. 15, 2017

(54) PATTERNED MAGNETIC SHIELDS FOR INDUCTORS AND TRANSFORMERS

(71) Applicant: GLOBALFOUNDRIES INC., GRAND CAYMAN (KY)

(72) Inventors: Anthony K. STAMPER, Burlington, VT (US); Venkata Narayana Rao Vanukuru, Bangalore (IN)

(21) Appl. No.: 14/969,772

(22) Filed: Dec. 15, 2015

(51) Int. Cl. H01F 27/28; H01F 41/04

(52) U.S. Cl. CPC H01F 27/2885; H01F 27/2804; H01F 41/042; H01F 2027/2809

(57) ABSTRACT

The present disclosure relates to semiconductor structures and, more particularly, to patterned magnetic shields for inductors and methods of manufacture. The structure includes: an inductor structure formed over a wafer; and a patterned magnetic material formed on a plane above, below or above and below the wafer and at a distance away from the inductor structure so as to not decrease inductance of the inductor structure.

### FIELD OF THE INVENTION

The present disclosure relates to semiconductor structures and, more particularly, to patterned magnetic shields for inductors and methods of manufacture.

### BACKGROUND

An inductor is an important component for an electric circuit with a resistor, a capacitor, a transistor and a power source. The inductor has a coil structure where a conductor is wound many times as a screw or spiral form. The inductor suppresses a rapid change of a current by inducing the current in proportion to an amount of a current change. A ratio of counter electromotive force generated due to electromagnetic induction according to the change of the current flowing in a circuit is called an inductance (L).

Generally, the inductor is used for an Integrated Circuit (IC) for communication. High performance RF filters, and distributed amplifiers, utilize inductors. In particular, inductors are used in a packaging technology for integrating many elements to a single chip, known as a System on Chip (SoC). Accordingly, an inductor having a micro-structure and good characteristics is needed.

Integrated Circuit (IC) are formed on chips which typically have grounded metal above and below them. Grounded TSV chips have a ground plane 50 to 150 microns below the on-chip inductor. Packaged chips typically have ground plane metal above and/or below them in the package. Chips mounted to circuit boards can have ground planes in the circuit boards. This leads to reduced spiral low inductance due to magnetic coupling with the backside or top side package metal.

### SUMMARY

In an aspect of the disclosure, a structure includes: an inductor structure formed over a wafer; and a patterned magnetic material formed on a plane above, below or above and below the wafer and at a distance away from the inductor structure so as to not decrease inductance achieved by the inductor structure.

In an aspect of the disclosure, a structure includes: an inductor structure formed over a wafer; and a patterned magnetic material formed on a plane above, below or above and below the wafer at a distance of about 50 to 150 microns away from the inductor structure and with an overlap from edges of the inductor structure of about 0% to 20%.

In an aspect of the disclosure, a method includes: forming an inductor structure formed over a wafer; depositing a magnetic material on a plane above, below or above and below the wafer and at a distance away from the inductor structure so as to not decrease inductance of the inductor structure; and patterning the magnetic material.

### BRIEF DESCRIPTION OF THE DRAWINGS

The present disclosure is described in the detailed description which follows, in reference to the noted plurality of drawings by way of non-limiting examples of exemplary embodiments of the present disclosure.

FIG. 1A shows a top view of a spiral inductor with a patterned magnetic material (e.g., patterned magnetic shields) and respective fabrication processes in accordance with aspects of the present disclosure.

FIG. 1B shows a high magnification view of the patterned magnetic layer, which is broken up into an array small shapes in accordance with aspects of the present disclosure.

FIG. 2A shows a cross-sectional view of an inductor with patterned magnetic material and respective fabrication processes in accordance with aspects of the present disclosure.

FIG. 2B shows an alternative embodiment of an insulator layer (e.g., oxide material) deposited on the exposed surface of the thinned wafer after the formation of backside metal and respective fabrication processes in accordance with aspects of the present disclosure.

FIG. 2C shows an alternative embodiment with insulator layer deposited over patterned magnetic material and respective fabrication processes in accordance with aspects of the disclosure.

FIG. 2D shows an alternative embodiment with insulator layer deposited on the wafer backside before patterned magnetic material is deposited and patterned in accordance with aspects of the disclosure.

FIGS. 3A and 3B shows show cross-sectional views of an inductor with patterned magnetic material and respective fabrication processes in accordance with aspects of the disclosure.

FIG. 4 shows a cross-sectional view of an inductor with patterned magnetic material and respective fabrication processes in accordance with additional aspects of the disclosure.

FIG. 5 shows a cross-sectional view of an inductor with patterned magnetic material and respective fabrication processes in accordance with aspects of the disclosure.

FIG. 6 shows a cross-sectional view of a 3D chip stacking option and respective fabrication processes in accordance with aspects of the invention.

FIG. 7 is a simulation graph showing improvement of inductance by implementing aspects of the present invention.

FIG. 8 is a simulation graph showing an improvement of quality implementing an inductor with a patterned magnetic layer in accordance with aspects of the invention

### DETAILED DESCRIPTION

The present disclosure relates to semiconductor structures and, more particularly, to patterned magnetic shields for inductors and methods of manufacture. In more specific embodiments, the present disclosure relates to an inductor with patterned magnetic material between the inductor and a ground plane. In alternate embodiments, the patterned magnetic material (e.g., patterned magnetic shields) can be an electrically floating plane above, below, or above and below an on-chip inductor. Advantageously, the patterned magnetic material (e.g., patterned magnetic shields) can shield magnetic coupling, which will improve L and Q characteristics of on-chip inductors. The patterned magnetic shields can also be implemented with a thinner substrate (than conventional structures) without degrading inductor performance.

The patterned magnetic shields of the present disclosure can be manufactured in a number of ways using a number of different tools. In general, though, the methodologies and tools are used to form structures with dimensions in the micrometer and nanometer scale. The methodologies, i.e., technologies, employed to manufacture the patterned magnetic shields of the present disclosure have been adopted from integrated circuit (IC) technology. For example, the structures are built on wafers and are realized in films of material patterned by photolithographic processes on the top of a wafer. In particular, the fabrication of the patterned magnetic shields uses three basic building blocks: (i) deposition of thin films of material on a substrate, (ii) applying a patterned mask on top of the films by photolithographic imaging, and (iii) etching the films selectively to the mask.

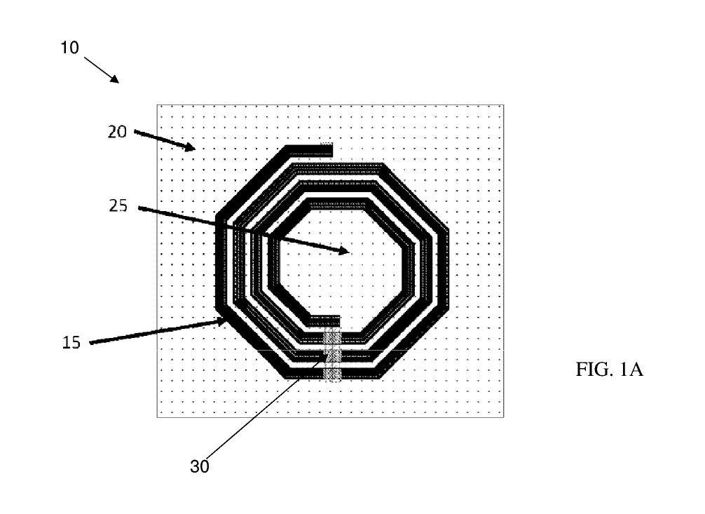

FIG. 1A shows a top view of a spiral inductor with a patterned magnetic material (e.g., patterned magnetic shields) in accordance with aspects of the present disclosure. In embodiments, the structure 10 can be representative of a multi-port inductor structure for use in semiconductor applications such as high-performance RF filters and amplifiers. The structure 10 includes a spiral inductor 15 with a backside metal layer 20. A patterned magnetic layer 25 is disposed between the spiral inductor 15 and the backside metal layer 20.

Referring still to FIG. 1A, in embodiments, the patterned magnetic layer 25 can be an electrically floating plane about 50 to 150 microns above, below, or above and below an on-chip inductor, e.g., spiral inductor. The patterned magnetic layer 25, unlike a solid plane of magnetic material attached to a package underside or wafer topside, will not increase inductance or reduce eddy current loops. In embodiments, the patterned magnetic layer 25 should preferably extend beyond an edge of the inductor 15 by 0-20%; although other extended regions are also contemplated by the present disclosure.

In embodiments, the magnetic material 25 can be CoTaZr alloy used with CMOS processes; although other magnetic materials are also contemplated to be used with the spiral inductor 15. In preferred embodiments, the magnetic material 25 should retain its properties up to about 400° C., and would have a permeability of about 870 and a ferromagnetic resonance of about 1.4 GHz. Moreover, the magnetic material 25 should have H, of approximately 0.2 Oe and a resistivity of about 100 μΩ.

Still referring to FIG. 1A, the spiral inductor 15 can include one or more metallization layers with vias structures 30 connecting each of the metallization layers. The spiral inductor 15 can be made of any metal material, for example, copper, tungsten, aluminum, or other suitable conductors or combinations thereof using conventional CMOS fabrication processes as noted herein. Also, although the metal wiring structures are shown in a spiral configuration with a certain number of spirals, other configurations are also contemplated herein, e.g., more or less spiral wiring segments and different shapes.

By way of one exemplary, non-limiting illustration, the metallization layers and vias structures 30 may be stacked on top of each other to conserve space. In embodiments, the metallization layers are arranged in a ring or spiral pattern, with the top ring patterns including a plurality of concentric bands, forming a spiral pattern, whereas, a bottom ring may include a broken ring pattern. Furthermore, high inductance and high Q values are provided across multiple frequency bands. The structure and performance provided by embodiments of the present invention make them well suited for silicon-on-insulator technologies.

FIG. 1B shows a high magnification view of the patterned magnetic layer 25, which is broken up into an array small shapes. In the illustration shown, the patterned magnetic shield is of a uniform mesh; however, other patterning shapes can also be used. In the illustration, the length and width of mesh walls are 2 μm with a spacing of 1 μm between them. Other lateral dimensions can be used as applicable. Increasing the mesh length/width improves the shielding. However, this results in increased eddy current losses in the shield.

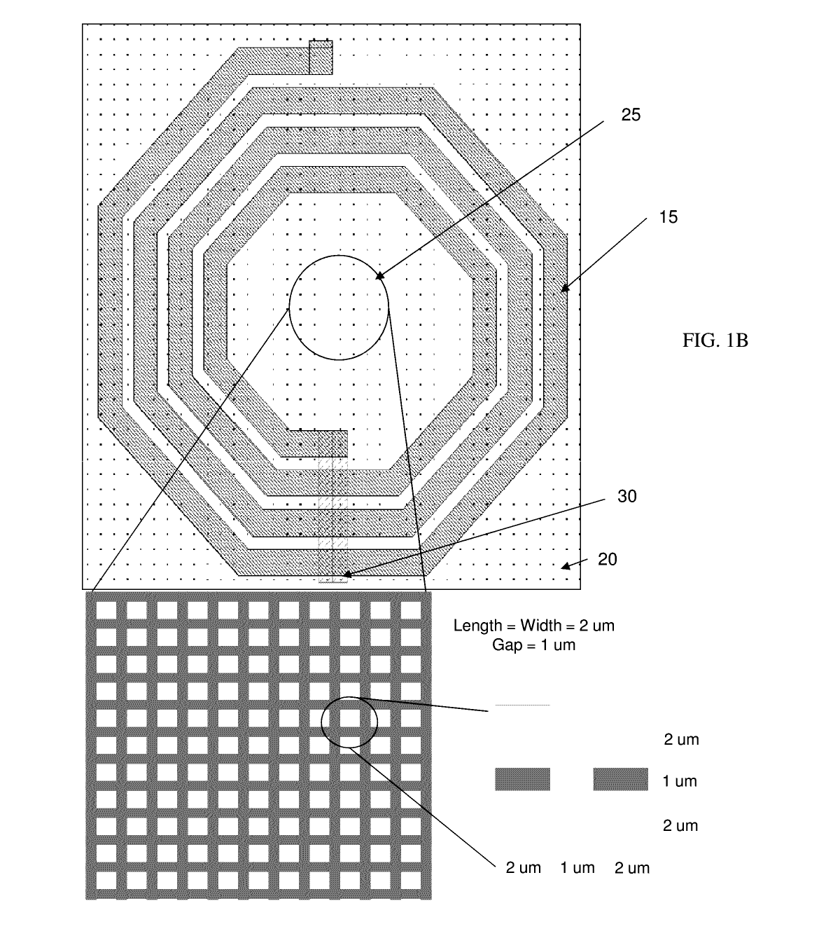

FIG. 2A shows a cross-sectional view of an inductor on a thinned undiced substrate, such as a glass, silicon, GaAs, etc. wafer, or a diced chip from the same thinned substrates with patterned magnetic material and respective fabrication processes in accordance with aspects of the disclosure. More specifically, the structure 10′ includes an inductor 15 formed above a wafer 35 within insulator or inter-level dielectric material 40, e.g., oxide based material (SiO₂). The inter-level dielectric material 40 is deposited on the wafer 35 using conventional deposition process such as chemical vapor deposition (CVD) processes. The inductor 15 is formed by conventional deposition and etching processes as should already be known to those of ordinary skill in the art such that further explanation is not required to understanding the present structure. As described herein, the inductor 15 can be a spiral inductor and can have many different metallization layers.

Front end of the line (FEOL) devices 45 are formed on the wafer 35 using conventional CMOS processes. One or more wiring structures 50 are formed on the inter-level dielectric material 40 also using conventional CMOS processes. The wiring structures can be any known metallization used in CMOS processes and can consist of multiple levels of wires and vias. A solder bump or copper pillar 70 is formed on the wiring structures 50, using bond pads in conventional processes.

In embodiments, the solder bump 70 can be, e.g., controlled collapse chip connections (C4 connections). As one of skill in the art would understand, C4 connections is a process for interconnecting semiconductor devices, such as integrated circuit chips to external circuitry with solder bumps that have been deposited onto chip pads. The solder bumps 70 are deposited on the chip pads on the top side of the wafer during the final wafer processing step. This is in contrast to wire bonding, in which the chip is mounted upright and wires are used to interconnect the chip pads to external circuitry. The bond pad can be any known metallurgy used for bond pad technologies, e.g., TiN followed by a copper seed layer. Alternatively, reference numeral 70 could be a copper pillar, or any known conductor for connecting the chip to a package or circuit board as known in the art.

A through silicon via (TSV) 55 extends from dielectric layer 40 or the top of wafer 35 to the thinned backside of substrate 35. The TSV 55 could be insulated from or grounded to the substrate 35. The TSV 55 is formed by patterning etching, and metallizing the wafer, as known in the art. The TSV 55 can be of any metal material such as tungsten or copper with optional refractory metal liners such as TiN, TaN, or Ta; and the TSV insulator, is present, can be any insulator, such as SiO2 deposited using, for example, CVD or ALD. The TSV is exposed for subsequent metallization 20 by thinning the substrate 35 backside, using known methods such as backside grind or etching. Metallization 20 is a ground plane in FIG. 2A but could be any known wafer backside TSV contact metallization including wiring, solder bumps, or copper pillars.

FIG. 2B shows an alternative embodiment where an insulator layer (e.g., oxide material) 60 can be deposited on the exposed surface of the thinned wafer 35 after the formation of backside metal 20 in accordance with aspects of the present disclosure. The deposition process can be, e.g., a chemical vapor deposition (CVD) process. A magnetic material 25 is blanket deposited on the insulator material 60, followed by patterning processes which includes lithographic and etching processes. The insulator layer 60 is planarized and, in embodiments, the magnetic material 25 can be formed directly in the dielectric layer 60 using a damascene process where trenches are patterned and etched into dielectric layer 60 followed by magnetic material deposition and CMP. For this and all of the embodiments, the magnetic material may be deposited with other liner materials, such as Ti, TiN, Ta, or TaN for purposes such as improved adhesion to oxide. As in each of the embodiments described herein, the magnetic material 25 can be patterned to extend at least to the edges of the inductor and preferably extends 0%-20% beyond the edges of the inductor 15 as designated by reference “x”.

In embodiments, the magnetic material 25 can be deposited to a thickness of about 10 microns and, more particularly, about 2 to 4 microns. The magnetic material 25 is also vertically spaced away from the inductor 15 by about 50 to 150 microns. Additionally, the patterning can be of many different shapes and designs such as a slotted design. In embodiments, the patterning of the magnetic material 25 would not increase inductance and will reduce any eddy current loops. Accordingly, in a preferred embodiment, the spacing of the patterned, e.g., slots, will be as small as allowable by design rules, e.g., 0.5 μm-5 μm, depending on the thickness of the magnetic material. In embodiments a backside metal 20 is formed in contact with the TSV before or after formation of the backside magnetic material 25. The backside metal 20 can be patterned and etched leaving areas on the substrate 35 backside with magnetic material 25, backside metal 20, or no backside metal. Alternatively, backside metal 20 could be the same magnetic material used for layer 25 and both would be deposited and patterned in a single step.

FIG. 2C shows an alternative embodiment with insulator layer 65 deposited over patterned magnetic material 25 in accordance with aspects of the disclosure. In this embodiment, magnetic material 25 is deposited and patterned using damascene or subtractive etch processing followed by the deposition of an insulator layer (e.g., oxide material) 65 on the patterned magnetic material 25. The insulator would then be optionally polished, via 200 is then patterned, etched, and metallized to contact TSV 55, followed by backside metal formation 20.

FIG. 2D shows an alternative embodiment with insulator layer 60 deposited on the wafer backside before patterned magnetic material 25 is deposited and patterned in accordance with aspects of the disclosure. In this embodiment, an insulator layer (e.g., oxide material) 65 is blanket deposited on the patterned magnetic material 25. Via 200 is then patterned and metallized to contact TSV 55, followed by backside metal formation 20.

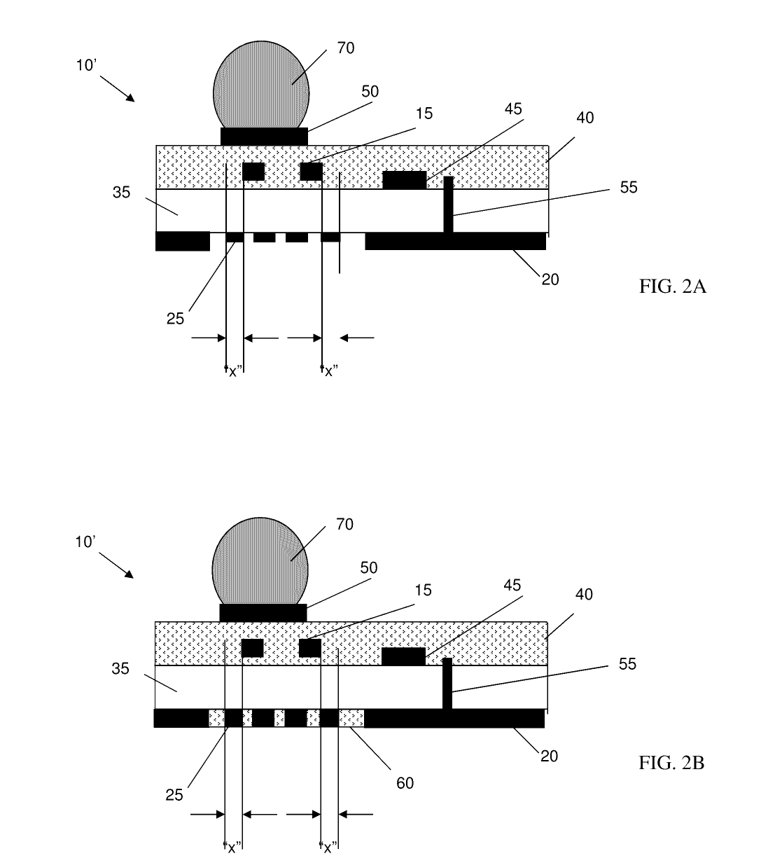

FIGS. 3A and 3B show cross-sectional views of an inductor with patterned magnetic material and respective fabrication processes in accordance with aspects of the disclosure. More specifically, the structure 10″ includes an inductor 15 formed above a wafer (e.g., silicon wafer) 35 within insulator or inter-level dielectric material 40, e.g., oxide based material (SiO₂). The inter-level dielectric material 40 is deposited on the wafer 35 using conventional deposition process such as chemical vapor deposition (CVD). The inductor 15 is formed by conventional deposition and etching processes and, as described herein, can be a spiral inductor and can have many different metallization layers. Front end of the line (FEOL) devices 45 are formed on the wafer 35 and wiring structures 50 are formed on the inter-level dielectric material 40, using conventional CMOS processes. A solder bump or copper pillar 70 is formed on the wiring structures 50, using bond pads in conventional processes.

After optional wafer 35 back side thinning using known methods such as backside grind and polish, a magnetic material 25 is blanket deposited on the insulator material 60, followed by patterning processes which includes lithographic and etching processes, as shown in FIG. 3A. In embodiments, the magnetic material 25 can be deposited to a thickness of about 10 microns and, more particularly, about 2 to 4 microns. An optional insulator layer (e.g., oxide material) 60 can be deposited on the exposed surface of the wafer 35, as shown in FIG. 3B. The deposition process can be, e.g., a chemical vapor deposition (CVD) process. The optional insulator layer 60 can be deposited on the wafer backside after thinning and before patterned magnetic material 25 formation.

The magnetic material 25 is also spaced away from the inductor 15 by about 50 to 50 microns. As in each of the embodiments described herein, the magnetic material 25 can be patterned to extend at least to the edges of the inductor and preferably extends 0%-20% beyond the edges of the inductor 15 as designated by reference “x”.

Additionally, the patterning can be of many different shapes and designs such as a slotted design. In embodiments, the patterning of the magnetic material 25 should not increase inductance and will reduce any eddy current loops. Accordingly, in a preferred embodiment, the spacing of the patterned, e.g., slots, will be as small as allowable by design rules as noted herein. It should be understood by those of ordinary skill in the art that each of the embodiments can include a slotted pattern for the patterned magnetic material 25.

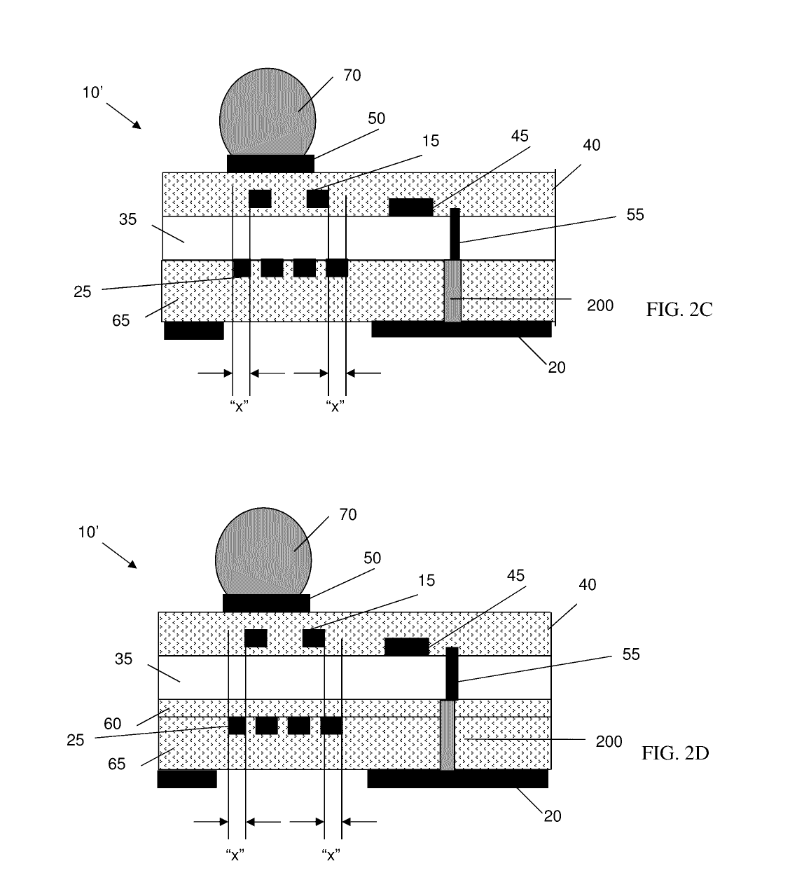

FIG. 4 shows a cross-sectional view of an inductor with patterned magnetic material and respective fabrication processes in accordance with additional aspects of the disclosure. This embodiment starts with a silicon on insulator (SOI) wafer with devices, wires, etc. formed on the front side of the wafer. The starting SOI wafer comprises a thick handle wafer, on the order of 0.7 microns thick, a buried oxide layer, on the order of 0.03 to 4 microns thick, and a top silicon layer, on the order of 0.03 to 4 microns thick. In this embodiment, the SOI handle wafer is removed post wafer front side processing and replaced with a low rf loss substrate, such as glass, sapphire, or high resistivity silicon. High resistivity silicon could have resistivity of greater than 1000 ohm-cm and, in one exemplary embodiment, has resistivity greater than 7500 ohm-cm.

More specifically, the structure 10′″ includes an inductor 15 formed above a wafer (e.g., glass wafer) 35′ within insulator or inter-level dielectric material 40, e.g., oxide based material (SiO₂). The inter-level dielectric material 40 is deposited on the devices 45, such as transistors formed on the thin silicon layer, inductor 15 formed in the inter-metal dielectric 40 using wiring levels, and pads or bump connections for packaging. Front end of the line (FEOL) devices 45 are formed on the insulator layer 75, and wiring structures 50 are formed on the inter-level dielectric material 40. A solder bump 70 is formed on the wiring structures 50, using bond pads in conventional processes. The inductor 15 is formed by conventional deposition and etching processes and, as described herein, can be a spiral inductor and can have many different metallization layers.

The original SOI handle wafer is replaced with glass or high resistivity silicon using known methods where the post BEOL process SOI wafer front side is attached to a temporary top handle wafer, the SOI handle silicon is removed by grinding, polishing, and/or etching down to the BOX oxide 75, the BOX bottom surface is attached to a permanent glass, sapphire, or high resistivity silicon wafer, and the temporary top handle wafer is removed, as known in the art. In embodiments, the magnetic material 25 can be deposited to a thickness of about 10 microns and, more particularly, about 2 to 4 microns on the wafer 60 bottom surface. As in the previous embodiments, an insulator layer could be deposited on the substrate 60 backside prior to magnetic material 25 formation. The magnetic material 25 is also spaced away from the inductor 15 by about 50 to 150 microns.

As in each of the embodiments described herein, the magnetic material 25 can be patterned to extend at least to the edges of the inductor and preferably extends 0%-20% beyond the edges of the inductor 15 as designated by reference “x”. Additionally, the patterning can be of many different shapes and designs such as a slotted design. In embodiments, the patterning of the magnetic material 25 should not increase inductance and will reduce any eddy current loops. Accordingly, in a preferred embodiment, the spacing of the patterned, e.g., slots, will be as small as allowable by design rules as noted herein.

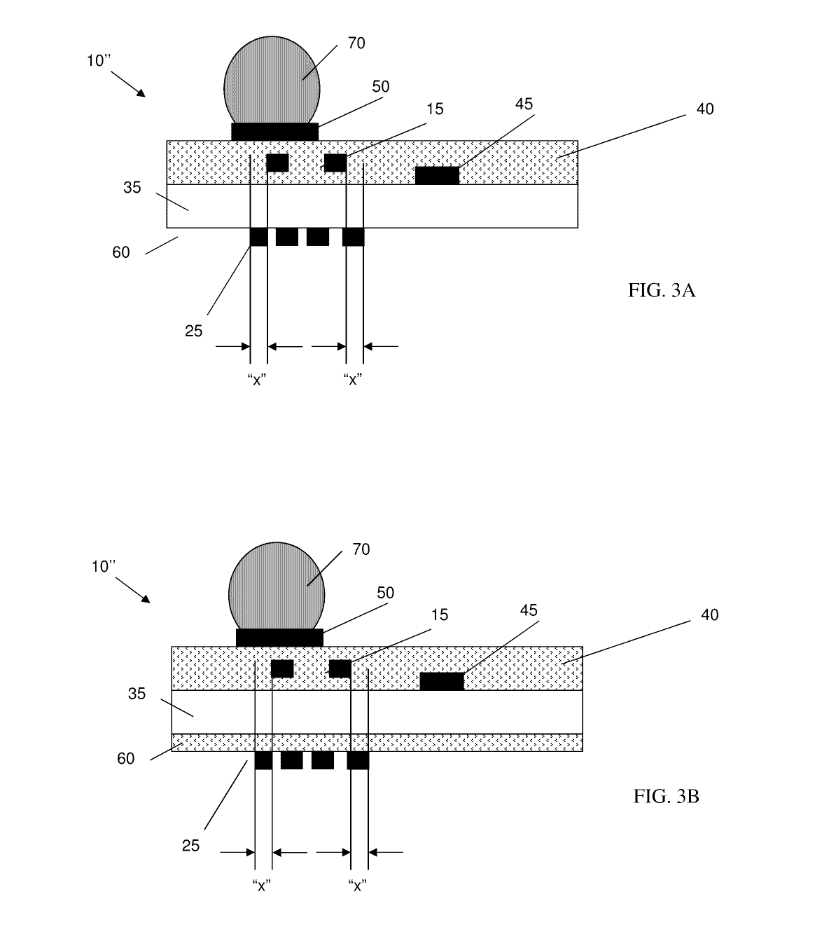

FIG. 5 shows a cross-sectional view of an inductor with patterned magnetic material and respective fabrication processes in accordance with aspects of the disclosure. More specifically, the structure 10″″ includes an inductor 15 formed above a wafer 35 (e.g., silicon wafer or glass wafer) within insulator or inter-level dielectric material 40, e.g., oxide based material (SiO₂). The inter-level dielectric material 40 is deposited on the wafer 35 using conventional deposition processes such as chemical vapor deposition (CVD). The inductor 15 is formed by conventional deposition and etching processes and, as described herein, can be a spiral inductor and can have many different metallization layers. Front end of the line (FEOL) devices 45 are formed on the wafer 35, and wiring structures 50 are formed on the inter-level dielectric material 40. In embodiments, the wiring structures 50 can a bond pad for a solder bump 70. The bond pad can be any known metallurgy used for bond pad technologies, e..g., TiN followed by a copper seed layer. In embodiments, the solder bump 70 can be, e.g., controlled collapse chip connections (C4 connections).

An insulator layer (e.g., oxide material) 80 can be deposited on the inter-level dielectric material 40 and solder bump or copper pillar 70, leaving a portion thereof exposed. A magnetic material 25 is blanket deposited on the insulator material 80, followed by patterning processes which includes lithographic and etching processes. In embodiments, the magnetic material 25 can be deposited to a thickness of about 10 microns and, more particularly, about 2 to 4 microns. The magnetic material 25 is also spaced away from the inductor 15 by about 50 to 150 microns. As in each of the embodiments described herein, the magnetic material 25 can be patterned to extend at least to the edges of the inductor and preferably extends 0%-20% beyond the edges of the inductor 15 as designated by reference “x”. Additionally, the patterning can be of many different shapes and designs such as a slotted design. In embodiments, the patterning of the magnetic material 25 should not increase inductance and will reduce any eddy current loops. Accordingly, in a preferred embodiment, the spacing of the patterned, e.g., slots, will be as small as allowable by design rules as noted herein. Also, this embodiment can include an optional ground plane 20′ on an opposing side of the structure 10″″. Substrate 35 could be any substrate material, including bulk silicon, SOI handle silicon, glass, sapphire, high resistivity silicon, etc. as known in the art.

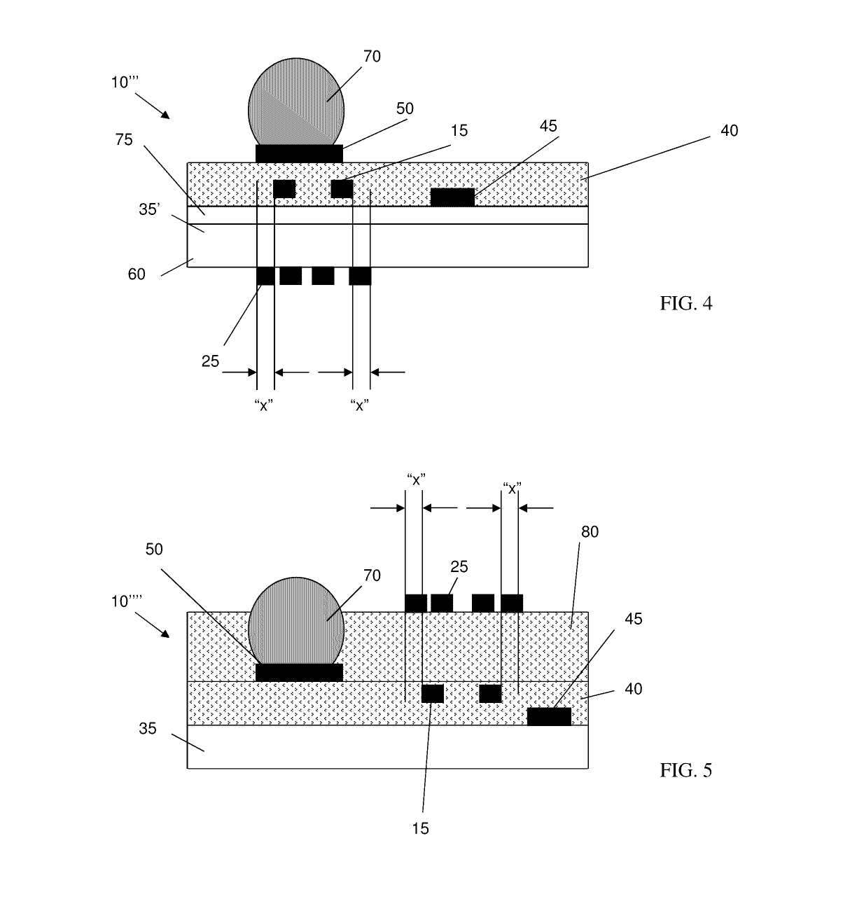

FIG. 6 shows a cross-sectional view of a 3D chip stacking option in accordance with aspects of the invention. As shown in this alternative embodiment, the structure 10″″ which includes a patterned magnetic material 25 can be placed or used whenever there is a ground plane in the package or chip. Also, as shown in FIG. 6, the patterned magnetic material 25 can be placed above, below or both above and below the on-chip inductor 15. Also, in this representation, wiring structures 85 are connecting together the package 10″″.

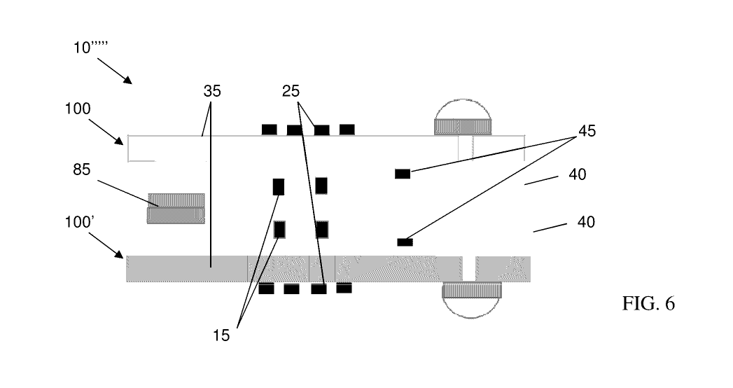

FIG. 7 is a simulation graph showing improvement in inductance implementing an inductor with a patterned magnetic layer in accordance with aspects of the invention. In particular, the graph shows an improvement in inductance of 15% using the inductor with the patterned magnetic layer in accordance with the different aspects described herein, as depicted by line “A”. The inductor is a parallel stacked spiral inductor (20 (W)×10 (S)×3.5 (N)×400 (OD)), with a substrate thickness of 60 μm, permeability of 5, magnetic material thickness of 10 μm and BSM conductivity of 3.5×10⁶ S/m.

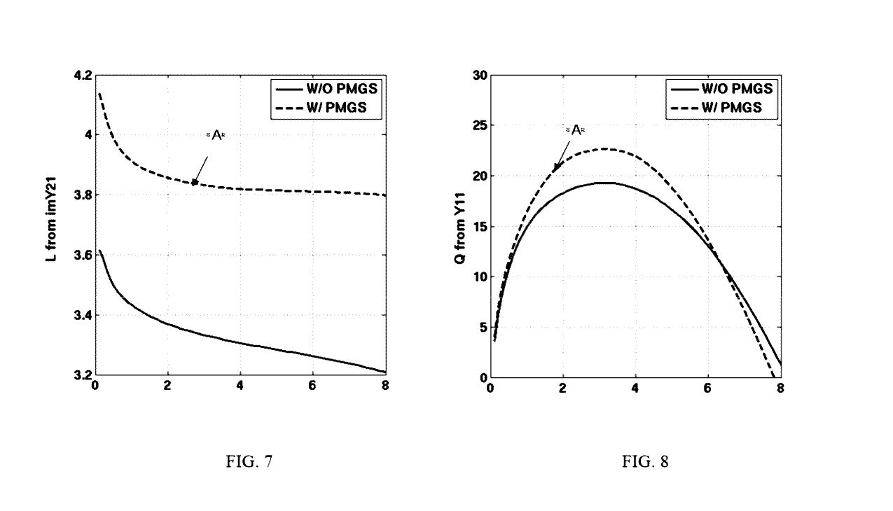

FIG. 8 is a simulation graph showing an improvement of quality implementing an inductor with a patterned magnetic layer in accordance with aspects of the invention. In particular, the graph of FIG. 8 shows an improvement in quality of 17% using the inductor with patterned magnetic layer in accordance with the different aspects described herein as shown by line “A”. The inductor is a parallel stacked spiral inductor (20 (W)×10 (S)×3.5 (N)×400 (OD)), with a substrate thickness of 60 μm, permeability of 5, magnetic material thickness of 10 μm and BSM conductivity of 3.5×10⁶ S/m.

The method(s) as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A structure, comprising:
an inductor structure formed over a wafer; and
a patterned magnetic material formed on a plane above, below or above and below the wafer and at a distance away from the inductor structure so as to not decrease inductance achieved by the inductor structure.

2. The structure of claim 1, wherein the patterned magnetic material is patterned into slots.

3. The structure of claim 1, wherein the patterned magnetic material is located below the wafer, and the structure further comprises a backside ground plane positioned below the patterned magnetic material and connected by a through silicon via.

4. The structure of claim 1, wherein the patterned magnetic material extends beyond edges of the inductor structure.

5. The structure of claim 4, wherein the patterned magnetic material extends beyond edges of the inductor structure by about 20%.

6. The structure of claim 1, wherein the patterned magnetic material is an electrically floating plane about 50 to 150 microns above, below, or above and below the inductor structure.

7. The structure of claim 6, wherein the patterned magnetic material is CoTaZr alloy.

8. The structure of claim 1, wherein the patterned magnetic material is located on the plane over the wafer and is combined with solder bumps or Cu pillars and a ground plane in package or on circuit board.

9. The structure of claim 1, wherein the wafer is a glass wafer.

10. The structure of claim 1, wherein the wafer is a silicon wafer.

11. The structure of claim 1, further comprising stacking of the structure of claim 1 with a second structure comprising:
an inductor structure formed over a wafer; and
a patterned magnetic material formed on a plane above, below or above and below the wafer and at a distance away from the inductor structure so as to not increase inductance of the inductor structure.

12. A structure, comprising:
an inductor structure formed over a wafer; and
a patterned magnetic material formed on a plane above, below or above and below the wafer at a distance of about 50 to 150 microns away from the inductor structure and with an overlap from edges of the inductor structure of about 0% to 20%.

13. The structure of claim 12, wherein the patterned magnetic material is patterned into slots.

14. The structure of claim 12, further comprising a backside ground plane positioned below the patterned magnetic material and connected by a through silicon via.

15. The structure of claim 12, wherein the patterned magnetic material is an electrically floating plane

16. The structure of claim 12, wherein the patterned magnetic material is CoTaZr alloy.

17. The structure of claim 12, wherein the patterned magnetic material is located on the plane over the wafer and is combined with solder bumps or Cu pillars and a ground plane in package or on circuit board.

18. The structure of claim 12, wherein the wafer is a glass wafer.

19. The structure of claim 12, wherein the wafer is a silicon wafer.

20. A method comprising:
forming an inductor structure formed over a wafer;
depositing a magnetic material on a plane above, below or above and below the wafer and at a distance away from the inductor structure so as to not decrease inductance of the inductor structure; and
patterning the magnetic material.
